(19) United States
(12) Patent Application Publication
(10) Pub. No.: US 2010/0166968 A1
(43) Pub. Date: Jul. 1, 2010

(54) Method for Treating a Paper Product

(75) Inventors: William Orlando Sinclair Doherty, Calamvale (AU); Peter Halley, Fairfield (AU); Dylan Cronin, Taringa (AU); Leslie Alan Edye, Highland Park (AU)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: SUGAR INDUSTRY INNOVATION PTY LTD, St Lucia (AU)

(21) Appl. No.: 12/668,412

(22) PCT Filed: Jul. 11, 2008
(86) PCT No.: PCT/AU2008/001020

§ 371 Date: Jan. 8, 2010

(30) Foreign Application Priority Data
Jul. 13, 2007 (EP) 07112475.4

(51) Int. Cl. B05D 3/02; B05D 1/36; C08L 97/00

(52) U.S. Cl. 427/387; 427/402; 427/395; 524/72; 106/218

(57) ABSTRACT

A method is provided for treating a paper product, the method comprising; providing a mixture comprising lignin in an aqueous solution at a concentration and pH such that substantially all the lignin is solubilised; treating the paper product with a cationic polymer followed by treating the paper product with the lignin mixture.

### FIELD OF THE INVENTION

The present invention relates to a method of treating a paper product to provide a moisture and/or oil resistant barrier to the material and a paper product treated by that method.

### BACKGROUND OF THE INVENTION

The present invention will be described with particular reference to paper packaging products. However, it will be appreciated that the method of the present invention may be used to treat any desirable paper product so as to provide a water and/or oil resistant barrier.

In the present specification, the term “paper product” includes any material formed or otherwise derived from a cellulose pulp. Such material includes papers, containerboard, paperboard, corrugated containers, recycled paper products and the like.

It is well known to coat or laminate a paper product to provide a moisture resistant and/or oil and grease resistant barrier. Wax is a commonly used paper coating. Waxed paper cannot be recycled and used waxed paper is either disposed of as landfill or incinerated. These options are environmentally unacceptable.

Paper products are also laminated with plastic films such as polyethylene and polypropylene. Recycling of these materials requires separation of the plastic laminate from the paper. This adds to recycling costs, together with the additional burden of disposing or recycling the separated plastic. Further, not all paper recycling operations have this facility such that a considerable proportion of laminated paper products are not recycled.

It is clearly desirable to be able to provide an alternative to waxed coatings and/or plastic laminates and which coating is able to be recycled.

Lignin, together with cellulose and polysaccharides are the major components of the cell walls of woody plants.

It is an accepted view that phenylpropane (i.e., C₉) repeat units linked to each other by ether and carbon-carbon bonds comprises the majority of the composition of lignin.

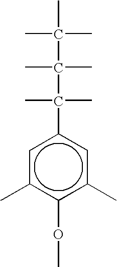

### A Phenylpropane (C₉ Unit)

Woody plants synthesise lignin from trans-p-coumaryl alcohol, trans-coniferyl alcohol, and trans-sinapyl alcohol by an enzymatic dehydrogenation initiated, free radical crosslinking process. Parts of the phenylpropane units containing the aromatic ring and the aromatic substituents are called p-hydroxyphenyl (H), guaiacyl (G), and syringyl (S), respectively.

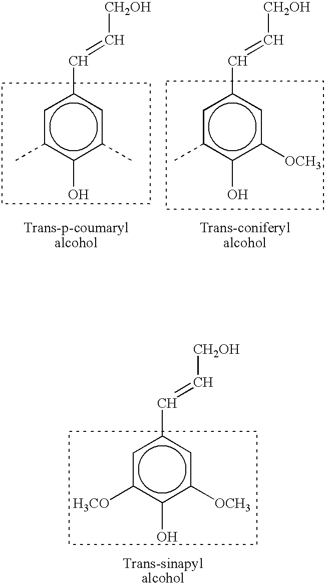

### The Lignin Precursors (i.e., Olignols)

Each class of plants, grasses, softwoods, and hardwoods produces a lignin rich in one type of the phenylpropane repeat unit. Sugarcane bagasse lignin (the preferred type of lignin used in the present invention), is a grass lignin and has a higher proportion of p-hydroxyphenyl lignin groups and lower methoxy content (i.e., vacant ortho and para sites on the aromatic groups) than softwood and hardwood.

Absorption of lignin onto cellulose fibres in solution has been studied. It was observed that a paper product having improved water resistance could be obtained by sequentially adding cationic starch and colloidal lignin to the pulp prior to forming the product. Use of the cationic starch negates the negative charge on the fibre surface which would under normal circumstances prevent the lignin from binding thereto.

It would be desirable to be able to treat a formed paper product to improve it's water resistance.

The present invention therefore relates to the use of lignin to treat a paper material so as to improve its water and/or oil resistance properties.

### SUMMARY OF THE INVENTION

According to a first broad form of the invention there is provided a method of treating a paper product, the method comprising providing an aqueous lignin mixture having a pH of at least about 8 and comprising at least some soluble lignin and applying the mixture to the paper product.

The paper product may be treated in any suitable manner including dipping, soaking, spraying, rolling, painting or the like.

According to a further broad form of the invention, there is provided a method of treating a paper product, the method comprising;

providing a mixture comprising lignin in an aqueous solution at a concentration and pH such that substantially all the lignin is solubilised;
treating the paper product with a cationic polymer followed by treating the paper product with the lignin mixture.

The two treatment steps for the cationic starch and the lignin may be the same or different.

The present inventors have observed that when a formed paper product is treated with cationic starch followed by colloidal lignin that the contact angle is actually lowered to below the control, or other words wettability actually increased. This is contrary to the expectation of the earlier work discussed above. Whilst not wishing to be bound by theory, the present inventors believe that colloidal lignin particles are bound to the surface of the cellulose fibres such that the nonbound cellulose surface presents a charged hydrophilic surface, such that the net effect is hydrophilic. The present inventors have surprisingly and unexpectedly discovered that by ensuring that most of the lignin is in a soluble form that the wettability and/or oil resistance of the surface of the paper product may be improved. Whilst not wishing to be bound by theory, it is believed that soluble lignin is able to be absorbed into the pores of the cellulose fibres.

Lignin is insoluble in water but is soluble at higher pH. Lignin carries a negative charge at higher pH. An aqueous lignin mixture may contain lignin in soluble and/or colloidal form, with the soluble form predominating at higher pH's. The pH at which lignin becomes completely soluble depends upon a number of factors such as the type of lignin (for example it's source and extraction procedures), concentration and temperature. Methods of assessing whether lignin is in a soluble or colloidal form are known to those of skill in the art. Such methods include using a scanning electron microscope to determine the existence of any phase boundaries. Absence of a phase boundary is indicative of the presence of only soluble lignin. Another method is simply to filter the solution and ascertain the amount, if any residue is left remaining.

The term “substantially all of the lignin is solubilised” means that the at least about 80 wt % of the lignin is in a soluble form, preferably at least 90 wt % and most preferably close to 100% wt.

Typical pH's of the lignin solutions is above about 9. A preferred range is between about 9.5 to about 11. Typical lignin concentrations are between about 0.02 g.L⁻¹ to about 20 g.L⁻¹ preferably between about 0.02 g.L⁻¹ to about 2 g.L⁻¹

The lignin is preferably dissolved in an ammonium solution. The advantage of using an ammonium solution is that ammonia may be volatilized during drying and/or curing.

The cationic polymer may be any suitable polymer including homopolymers of trimethylaminoethylacrylate chloride (TMAEAC) and diallyldeimethylammonium chloride (DADMAC), co-polymers of TMAEAC—acrylamide. A preferred polymer is cationic starch, typically having a degree of hydrolysis of 10% to 30%. Typically the cationic polyelectrolyte is present in a range of between about 100 ppm to about 200 ppm, preferably between about 200 ppm to about 1000 ppm.

The lignin treatment step may be carried out at a temperature of up to about 65° C.

It is preferred that after treatment, the paper product is heated to a temperature of between about 80° C. to about 100° C. This drives off ammonia and cures the coating. Heating may be effected in any suitable manner and typically occurs in an oven.

The present inventors have also discovered that an effective barrier may be obtained by treating the paper product with lignin in the presence of a crosslinking agent.

According to a further preferred form of the invention there is provided a method of treating a paper product, the method comprising;

providing an aqueous lignin mixture having a lignin concentration and pH such that the lignin is present in both soluble and colloidal form;
adding a crosslinking agent to the lignin mixture;
treating the paper product with the mixture; and
allowing the mixture to cure.

A crosslinking agent refers to an agent having at least two functional groups, at least one of which is capable of forming a bond with hydroxy groups.

Typically the pH is from about 8 to about 10. The concentration of lignin is the mixture is typically between about 10 wt % to about 30 wt %, most preferably about 20 wt %. These concentrations are typically higher than that used in the first broad form of the invention. It will be appreciated that higher concentrations may be tolerated in view of the fact that a certain amount of colloidal lignin may be present. It is estimated that at about pH 10 the amount of colloidal lignin is about 10 wt %.

A preferred particle size of the colloidal material is between about 20 to about 50 nm, preferably about 30 nm. The present inventor has observed that dispersions containing lignin particles in this size range have the ability to penetrate surfaces, particularly those containing cellulose fibres, have the ability to form films and stable mixtures, and have adequate rheological and viscoelastic properties.

At higher concentrations, it may be desirable to add a plasticizer to the mixture to improve the melt flow characteristics and provide a workable coating mixture. Suitable plasticizers are polyols. Preferred polyols are those rated for use with food. Typical polyols include the ethoxylated sorbitan esters, for example polyoxyethylene sorbitan monooleate, polyoxyethylene sorbitan monolaurate, polyoxyethylene sorbitan mono-oleate, polyoxyethylene sorbitan monopalmitate, polyoxyethylene sorbitan monostearate and polyoxyethylene sorbitan tristearate. Another preferred polyol is polyethylene glycol having a molecular weight of between about 4000 to about 10000, preferably about 6000.

Preferred crosslinking agents are bifunctional compounds having a first functional group reactive with hydroxyl groups and a second functional group having a double bond. Whilst not wishing to be bound by theory, the present inventors believe that the hydroxyl reactive groups form an ester linkage with the cellulose and the double bond forms a bond with the lignin.

Examples of suitable compounds are compounds (1) to (4) below:

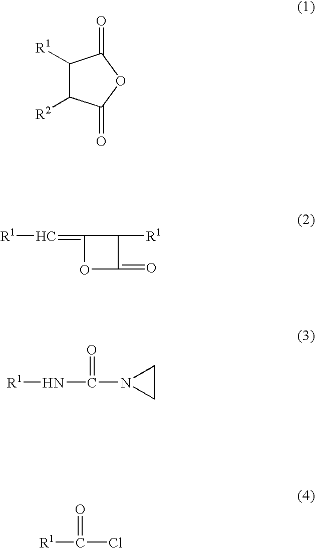

wherein R¹ is a C₃ to C₂₄ branched or unbranched chain having at least one double bond and R₂ is H or lower alkyl having from 1 to 6 carbon atoms. Especially preferred compounds are those of formula 1 and 2 known as alkenyl succinic anhydrides and alkylketene dimmers respectively. Especially preferred are alkenyl succinic anhydrides such as dodecynyl succinic anhydride, hexadecynyl succinic anhydride, ocatadecynyl succinic anhydride or mixtures of any two or more thereof.

Typically the crosslinking agent is present in the mixture at levels of between about 0.1 wt % to about 4 wt %, preferably between about 0.1 wt % to about 1 wt %.

According to a further broad form of the invention there is provided a composition for treating a paper product, the composition comprising lignin mixed in an aqueous solution at a concentration and pH such that the lignin is present in both soluble and colloidal form and a crosslinking agent.

Preferably, the paper product is pre-treated with a cationic polymer prior to treatment with the lignin mixture in a manner as described above with respect to the first broad form of the invention.

After treatment, the mixture is allowed to cure. This is typically done at elevated temperatures, typically between about 80 and about 100° C.

The present inventors have also unexpectedly discovered that adding an amphiphlic polymer that is capable of temperature dependent self assembly to a lignin solution prior to treatment of the paper product will also provide an acceptable coating.

According to a further broad form of the present invention, there is provided a method of treating a paper product, the method comprising;

providing an aqueous mixture of lignin having a concentration and pH such that at least some of the lignin is present in a soluble form;
adding an amphiphilic polymer to the lignin mixture, the amphiphilic polymer being capable of temperature dependent self assembly such that it becomes more hydrophobic with an increase in temperature;
treating the paper product with the mixture; and
allowing the mixture to cure.

Amphiphiles have a hydrophilic portion and a hydrophobic portion. In aqueous solution, amphiphiles self assemble such that the hydrophilic portion contacts the water molecules. Temperature can affect the orientation of an amphiphilic molecule in solution or on a surface molecule

Preferred amphiphilic polymers are silicone polyols. The structure of the silicone polyols comprises defined hydrophobic and hydrophilic portions. The hydrophobic portion comprises one or more dihydrocarbylsiloxane units. The hydrophilic portion of the polyol may comprise one or more polar moieties including ionic groups such as sulfate, sulfonate, phosphonate, phosphate ester, carboxylate, carbonate, sulfosuccinate, taurate, phosphine oxide (as the free acid, a salt or an ester), betaine, betaine copolyol, or quaternary ammonium salt. Ionic hydrophilic moieties may also comprise ionically functionalized siloxane grafts, including polyelectrolytes. Siloxane surfactants containing such groups include, for example, polydimethylsiloxane-graft-(meth)acrylic acid salts, polydimethylsiloxane-graft-polyacrylate salts and polydimethylsiloxane grafted quaternary amines.

The polar moieties of the hydrophilic portion may comprise non-ionic groups formed by polyethers, such as polyethylene oxide (PEO), and mixed polyethylene oxide/polypropylene oxide polyethers (PEO/PPO); mono- and disaccharides; and water-soluble heterocycles such as pyrrolidinone. The ratio of ethylene oxide to propylene oxide (EO/PO) may be varied in mixed polyethylene oxide/polypropylene oxide polyethers, from about 10 wt. % EO to 100 wt. % EO.

The hydrophilic portion may also comprise combinations of ionic and nonionic moieties. Such moieties include, for example, ionically end-functionalized or randomly functionalized polyether or polyol.

The arrangement of the hydrophobic and hydrophilic portions may take the form of a diblock polymer (AB), triblock polymer (ABA), wherein the “B” represents the siloxane portion of the molecule, or multi-block polymer. The silicone polyol may alternatively comprise a graft polymer. The term “graft polymer” refers to a polymer comprising molecules with one or more species of polymeric functionality connected to the main polymer backbone as side chains, wherein the sidechains, or grafts, have structural or functional characteristics that differ from the characteristics of the main polymer backbone. Each graft of a polymeric functionality to the main polymer backbone is a “pendant” group. The structure of the graft may be linear, branched or cyclic.

A graft polymer useful in the practice of the invention may comprise a hydrophobic main polymer backbone of dihydrocarbylsiloxane units to which one or more hydrophilic grafts are bonded. One structure comprising multiple grafts onto a main polymer backbone is a “rake” type structure (also called “comb”). A rake-type structure is compared to an ABA structure, below.

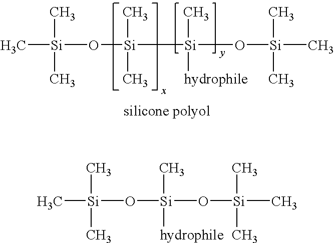

An especially preferred rake silicone polyol is one where the hydrophile has the formula C₃H₆O-(EO)m-(PO)n-R;
where EO is ethylene oxide —[CH₂—CH₂—O]m-; PO is propylene oxide —[CH₂—CH(CH₃)—O]n—, either, but not both, of m and n may be 0 and R is methyl, ethyl, butyl or propyl. X, y, m and/or n are selected such that the molecular weight of the polyol is between about 2000 to about 10000, typically between about 4000 and about 6000. Especially preferred are the rake silicone polyols available from Genesee.
A trisiloxane is an additional structure type, related to the rake-type structure. A representative trisiloxane structure is depicted below.

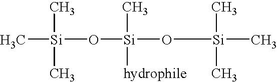

The siloxane portion of the molecule may be polymeric or oligomeric with regard to the dihydrocarbylsiloxane unit. Siloxane portions of the surfactant molecule may comprise linear, branched or cyclic structures.

Another suitable amphiphatic polymer is a N-vinyl caprolactam copolymer. A suitable comonomer is vinyl acetate.

Typically the amphiphile is present in the mixture in an amount of between 0.5 to about 4%, preferably between about 1 to about 2%.

The mixture may include lignin in colloidal form. The preferred particle sizes and relative amounts of colloidal to soluble lignin are similar to that described above.

After treatment, the mixture is allowed to cure. This is typically done at elevated temperatures, typically between about 80° C. and about 100° C.

According to a further preferred from of the invention there is provided a composition for treating a paper product, the composition comprising lignin mixed in an aqueous solution at a concentration and pH such that the lignin is present in both soluble and colloidal form and an amphiphilic polymer that is capable of temperature dependent self assembly to the lignin mixture whereby the polymer becomes more hydrophobic with an increase in temperature.

A preferred lignin for use in each embodiment of the present invention is derived from a non-wood source. An especially preferred lignin is derived from sugarcane bagasse. It is also preferred that the lignin is separated from the cellulose component of the bagasse by the soda pulping or organosolv processes. The organosolv process uses an organic solvent such as aqueous ethanol to separate the lignin. The soda process uses caustic soda under pressure. Lignin obtained by these processes is believed to be particularly suitable for use in the methods and compositions of the present invention as it as it has a relatively low molecular weight and narrower molecular weight distribution that lignin fractionated by the conventional kraft process. These lignins also tend to be more hydrophobic.

### DETAILED DESCRIPTION OF THE FIGURES

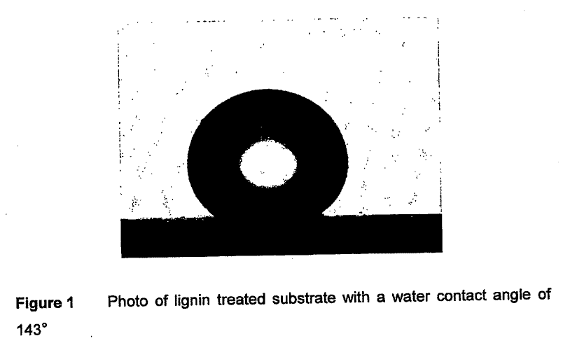

FIG. 1 is a photo of a paper product coated by a preferred method and composition of the present invention; and

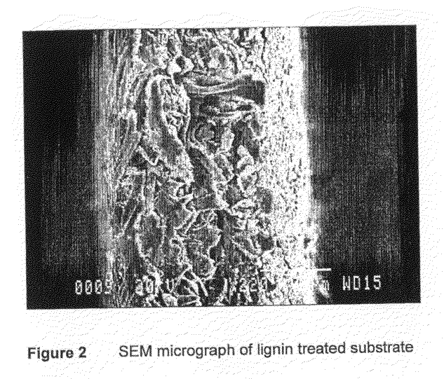

FIG. 2 is a SEM micrograph of a paper product treated by a preferred method and composition of the present invention.

### DETAILED DESCRIPTION OF THE INVENTION

### Lignin Purification

Sugarcane bagasse was pulped with a solution of aqueous ethanol in a Parr reactor at 190° C., which produced black liquor and pulp. This liquor was then diluted and heated to recover the lignin. The lignin was obtained by filtration, air-dried and further dried overnight in a vacuum oven at 60° C. The crude lignin was then dissolved in 0.1 M caustic soda solution and the resulting solution heated to 40° C. with stirring for 30 min. The lignin was then re-precipitated by acidifying with sulfuric acid to a pH of 5.5-6. By purifying the lignin in this manner the amount of proteins, polysaccharides, lipids and ash impurities were reduced.

### Substrate Preparation

The substrates were pre-treated by completely submerging them in beakers containing CS solutions at ˜23° C., 45° C. or 60° C. for ˜1 h. After this, they were removed and the excess solution allowed to drip, then lay flat to air-dry. This took ˜40 min. The pre-treated substrates were then either completely submerged in a beaker of lignin solution for 5 min, or a coating of the lignin solution was mechanically applied using a sponge roller. Like the starch solution, the lignin was applied at various temperatures, ranging from room temperature to 65° C. A hair-dryer was then used to dry the coated substrates before further drying in an oven at 100° C. overnight. The coated substrates were sandwiched between two panes of glass and clamped in an attempt to reverse the significant curling that occurred during oven drying. This provided a flat surface for contact angle measurements.

### Contact Angle Measurements

A contact angle of a sample represents the angle at which a liquid/vapour interface of a liquid droplet meets a solid surface. This value is measured using a video contact angle device, which calculates the value using the Young-Laplace equation and incorporates a contact angle goniometer for visual analysis of the droplet.

The contact angle is specific for any given system and is determined by the interactions across the three interfaces (liquid, vapour and solid). On an extremely hydrophilic surface a water droplet will completely spread out, resulting in an effective contact angle of 0°. On a hydrophobic surface however, a large contact angle is observed and often falls in the range of 70° to 90°. Once a contact angle of 150° is obtained, the surface is deemed superhydrophobic and the water droplet effectively rests atop the surface, without wetting it to any significant extent.

In the present investigation, contact angle measurements were used to quantify the performance of the treated substrates. FIG. 1 shows a photograph of a water droplet on a lignin coated substrate.

The contact angle for each substrate prepared was taken at least 2 (and up to 5), different locations to ensure an average value was obtained. For the majority of the substrates the value obtained indicates a static value, as the contact angle was observed not to change with elapsed time. However, for those (less successful) substrates whose contact angle did decrease with time, a second value is indicated in parenthesis. This value describes the angle obtained once the droplet appeared to have ceased spreading, and was usually taken at 1-1.5 min after the initial impact.

### Water Absorption Measurement

A qualitative measure of the relative water absorptive nature of the substrates was undertaken using a ‘5 min dunk test’. The substrates were submerged in a solution of ultra-pure water for 5 min. At the end of this the samples were removed from the solution and patted dry between two layers of paper toweling, to remove any excess surface moisture, before having their mass re-recorded. The difference in dry and wet mass of the substrate was then used to calculate its percentage increase in mass recorded due to water absorption.

### Coating Thickness

In an attempt to measure the approximate thickness of the lignin/cationic starch coating, several coated samples and a control sample were analysed using scanning electron microscopy (SEM).

A razor blade was used to cut a small portion of the samples, such that a fresh, clean-cut vertical cross section could be observed. It was thought that this would produce a clearly visible phase boundary between the substrate and coating, allowing for the measurement of the coating thickness.

Preliminary Results with Cationic Starch

### Solution Preparation

The Cationic Starch (CS) used for this study was WISPROFLOC P supplied by Swift and Co. Three concentrations of CS solutions were prepared 80 ppm, 250 ppm and 1,000 ppm. These solutions were heated to the desired temperature prior to use.

Three concentrations of lignin solutions in 0.1 M ammonia solution were prepared 0.2 g.L⁻¹, 2.0 g.L⁻¹ and 200 g.L⁻¹. There were left to stir overnight. The beakers containing the lignin solutions were tightly covered, so as to prevent loss of ammonia. The pHs of the lignin solutions containing 0.2 g.L⁻¹ and 2.0 g.L⁻¹ were 10.2-10.8. However, for the 200 g.L⁻¹ lignin solution the pH was raised just prior to application from 7.4 to 8, using the ammonia solution.

### Results

### Contact Angle and Water Absorption Results

The two lignin samples, one designated Dark/fine and the other designated Light/coarse were both obtained via aqueous ethanol extraction (see table 5.1). The samples differ only in the concentration of ethanol used in their extraction from the original bagasse as well as the pulping time.

TABLE 1
Composition of lignin solutions

| Solution | Type of | Lignin conc. | |
|---|---|---|---|
| code | lignin | (g · L⁻¹⁾ | pH |
| S1 | Dark/fine | 0.2 | 10.8 |
| S2 | Dark/fine | 2.0 | 10.4 |
| S3 | Light/coarse | 0.2 | not measured |
| S4 | Dark/fine | 200 | 7.4 |
| | | | (adjusted to 8.2) |

The substrate codes used in table 5.2 identify the procedural variables involved in preparing the individual substrates. For example, substrate 250-R-60 was prepared using 250 ppm CS solution at room temperature (R), followed by treatment with a lignin solution at 60° C.

Table 2 includes the contact angles observed for all test specimens prepared, as well as that for the untreated sample)(91°), and for an untreated sample that was heated overnight in the oven at 100° C. (101°). The contact angles for the treated samples were in the range of 90°-118°. The contact angles of the substrates prepared with a lignin concentration of 200 g.L⁻¹ were quite acceptable upon initial impact of the water droplet but decreased significantly over the course of a few minutes. This effect may be related to the pH of this solution which was ˜8.2 compared to a value of between 10.2 and 10.8 for the other lignin concentrations. At that pH and concentration, a significant portion of the lignin would be in colloidal form.

TABLE 2
Contact angles for both treated and untreated substrates

| Substrate | Dunked/ | Contact angle (°) | | | |
|---|---|---|---|---|---|
| code | Roller | S1 | S2 | S3 | S4 |
| 80-R-R | D | 110 | 108 | — | — |
| | R | 111 | 100 | — | — |
| 80-R-40 | D | 103 | 111 | — | — |
| | R | 112 | 95 | — | — |
| 80-45-R | D | 108 | 109 | — | — |
| | R | 90 | 104 | — | — |
| 80-45-40 | D | 101 | 109 | — | — |
| | R | 104 | 104 | — | — |
| 80-60-R | D | 101 | 110 | — | — |
| | R | 93 | 99 | — | — |
| 80-60-40 | D | 97 | 109 | — | — |
| | R | 93 | 100 | — | — |
| 250-R-R | D | 108 | 114 | 109 | 110 (60) |
| | R | 105 | 102 | 108 | — |
| 250-R-40 | D | 103 | 114 | 108 | — |
| | R | 101 | 109 | 107 | — |
| 250-R-60 | D | — | 116 | 116 | — |
| | R | — | 106 | 111 | — |
| 250-45-R | D | 107 | 118 | 107 | — |
| | R | 105 | 104 | 99 | — |
| 250-45-40 | D | 103 | 114 | 110 | — |
| | R | 104 | 105 | 96 | — |
| 250-45-60 | D | — | 115 | 112 | — |
| | R | — | 109 | 105 | — |
| 250-60-R | D | 105 | 111 | 102 | — |
| | R | 103 | 105 | 104 | — |
| 250-60-40 | D | 103 | 116 | 107 | — |
| | R | 105 | 106 | 102 | — |
| 250-60-60 | D | — | 115 | 109 | — |
| | R | — | 107 | 104 | — |
| 1000-R-R | D | 105 | 114 | — | 110 (55) |
| | R | 106 | 101 | — | — |
| 1000-R-40 | D | 113 | 114 | — | — |
| | R | 105 | 105 | — | — |
| 1000-R-60 | D | — | 117 | — | 104 (70) |
| | R | — | 105 | — | — |
| 1000-45-R | D | 109 | 112 | — | — |
| | R | 105 | 98 | — | — |
| 1000-45-40 | D | 107 | 114 | — | — |
| | R | 97 | 100 | — | — |
| 1000-45-60 | D | — | 116 | — | — |
| | R | — | 102 | — | — |
| 1000-60-R | D | 108 | 109 | — | — |
| | R | 98 | 105 | — | — |
| 1000-60-40 | D | 111 | 112 | — | — |
| | R | 101 | 99 | — | — |
| 1000-60-60 | D | — | 115 | — | — |
| | R | — | 105 | — | — |

| | |
|---|---|
| Uncoated substrate | 91 |
| Heat-treated (uncoated) | 101 |
| substrate | |

Table 3 gives the water absorption results for the untreated substrate and CS treated substrates. The increase in mass for the CS treated substrates ranged from 53%-69% slightly lower than the untreated substrate i.e., control.

TABLE 3
Water absorption results for the untreated and CS treated
substrates

| | Increase in mass |
|---|---|
| Substrate code | (%) |
| Control | 72 |
| 250-R | 53 |
| 250-60 | 69 |
| 1000-R | 55 |
| 1000-60 | 59 |

Table 4 gives the water absorption results for the lignin coated substrates. The increase in mass is between 52% and 64%, slightly lower than the untreated substrate.

TABLE 4
Water absorption results for the lignin treated substrates

Increase in Mass (%)

| Substrate code | Dunked/Roller | S1 | S2 |
|---|---|---|---|
| 250-R-R | D | 64 | 60 |
| 250-R-R | R | 62 | 64 |
| 250-R-65 | D | 70 | 57 |
| 250-R-65 | R | 57 | 52 |
| 1000-R-R | D | 57 | 60 |
| 1000-R-R | R | 63 | 61 |
| 1000-R-65 | D | 62 | 63 |
| 1000-R-65 | R | 59 | 61 |

### SEM Analysis

The use of SEM to determine the thickness of any coating proved unsuccessful as no obvious phase boundary was seen. This was probably because, at least for the dilute lignin solutions (0.2 g.L⁻¹ and 2.0 g.L⁻¹), the lignin macromolecules only occupied the pores and spaces between the fibres of the substrate. A SEM micrograph is shown in FIG. 2.

### FURTHER EXAMPLES

In each of the further examples, the coating was painted onto the substrate and cured at a temperature at 80° to 100° C. for a time sufficient to cure the formulation.

### Example 1

A lignin solution was made by mixing lignin with ammonia solution such that the pH was 10. This solution was then made into a formulation consisting of components shown in table 1. The solution temperature was between 25° C. and 60° C.

### Lignin/Silicon Polyol Coating Formulation

| Component | Weight % |
|---|---|
| Lignin | 20 |
| Genesee 218 | 2 |
| Ammonia solution | 78 |

The contact angle of the coated substrates where taken after 1-2 min to take into account spreading of the water droplet and as such water penetration. The contact angle of the coated paper was 132° C.

### Example 2

The lignin solution of Example 1 was incorporated into the formulation as shown below.

### Lignin/Silicon Polyol Coating Formulation

| Component | Weight % |
|---|---|
| Lignin | 20 |
| Genesee 218 | 4 |
| Ammonia solution | 78 |

The contact angle measurement of the coated paper taking after 1-2 min was 134°.

### Example 3

The lignin solution of Example 1 was incorporated into the formulation as shown below.

### Lignin/Silicon Polyol Coating Formulation

| Component | Weight % |
|---|---|
| Lignin | 20 |
| Genesee 226 | 2 |
| Ammonia solution | 78 |

The contact angle measurement of the coated paper taking after 1-2 min was 115°.

### Example 4

The lignin solution of Example 1 was incorporated into the formulation as shown in below.

### Lignin/Polyol/ODSA Coating Formulation

| Component | Weight % |
|---|---|
| Lignin | 20 |
| Polyethylene glycol, | 2 |
| 6000 | |
| ODSA | 0.3 |
| Ammonia solution | 77.7 |

The contact angle measurement of the coated paper taking after 1-2 min was 125°. Water adsorption 37%; control 51%. Kit test, 4. Water vapour transmission rate (WVTR) 468 gm²/24 hours.

### Example 5

The lignin solution of Example 1 was incorporated into the formulation as shown below.

### Lignin/Polyol/ODSA Coating Formulation

| Component | Weight % |
|---|---|
| Lignin | 20 |
| Polyethylene glycol, | 4 |
| 6000 | |
| ODSA | 0.6 |
| Ammonia solution | 75.4 |

The contact angle measurement of the coated paper taking after 1-2 min was 115°. Water adsorption 31%; control 51%. Kit test, 4. WVTR 460 gm²/24 hours.

### Example 6

The lignin solution of Example 1 was incorporated into the formulation as shown below.

### Lignin/Cationic Starch Coating Formulation

| Component | Weight % |
|---|---|
| Lignin | 0.02 |
| Ammonia solution | 99.98 |

The paper substrate was contacted with ˜0.025 g.L⁻¹ cationic starch (WISPROFLOC P).

The contact angle measurement of the coated paper taking after 1-2 min was 108°.

### Example 7

The lignin solution of Example 1 was incorporated into the formulation as shown below.

### Lignin/Cationic Starch Coating Formulation

| Component | Weight % |
|---|---|
| Lignin | 0.2 |
| Ammonia solution | 99.8 |

The paper substrate was contacted with ˜0.1 g.L⁻¹ cationic starch (WISPROFLOC P).

The contact angle measurement of the coated paper taking after 1-2 min was 112°.

It may be seen that the methods and compositions of the present invention are able to increase the contact angle of the surface of a paperboard product. It may also be seen from the above examples that the treated paper products had an acceptable kit value. A kit value represents the ability of a surface to repel grease and oil.

Paper products treated by the present invention are able to be recycled and are also biodegradable. As the mixtures and solutions are aqueous, the use of the present invention avoids the use of organic solvents currently employed in the paper coating industry. Thus the present invention may be able to reduce the amount of volatile organic compounds and hazardous air pollutants being introduced into the environment.

In the specification and the claims the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

It will be appreciated that various changes and modifications may be made to the invention described and claimed herein without departing from the spirit and scope of the invention.

1. A method of treating a paper product, the method comprising:
providing a mixture comprising lignin in an aqueous solution at a concentration and pH such that at least about 80 wt % of the lignin is solubilised; and
treating the paper product with a cationic polymer followed by treating the paper product with the lignin mixture.

2. The method of claim 1, wherein the treatment improves the water resistance of the paper product.

3. The method of claim 1, wherein the solution has a pH of between about 9.5 to about 11.

4. The method of claim 1, wherein at least about 90 wt % of the lignin is solubilised.

5. The method of claim 1, wherein the lignin concentration is between about 0.02 g.L⁻¹ to about 20 g.L⁻¹.

6. The method of claim 5, wherein the lignin concentration is between about 0.02 g.L⁻¹ to about 2 g.L⁻¹.

7. The method of claim 1, wherein the cationic polymer is a cationic starch.

8. The method of claim 7, wherein the cationic starch has a degree of hydrolysis of 10% to 30%.

9. The method of claim 1, wherein the cationic polymer is present in a range of between about 200 ppm to about 1000 ppm.

10. The method of claim 1, wherein the aqueous solution comprises ammonia.

11. The method of claim 1, wherein after treatment with the lignin mixture, the paper product is heated to a temperature of between about 80° C. to about 100° C.

12. The method of claim 1, wherein the lignin is obtained from sugar cane bagasse.

13. The method of claim 12, wherein the lignin has been fractionated from the bagasse by an organosolv or soda process.

14. (canceled)

15. A method of treating a paper product, the method comprising;
providing an aqueous lignin mixture having a lignin concentration and pH such that the lignin is present in both soluble and colloidal form;
adding a crosslinking agent to the lignin mixture;
treating the paper product with the mixture; and
allowing the mixture to cure.

16. The method of claim 15, wherein the mixture has a pH of between about 8 to about 10.

17. The method of claim 15, wherein the concentration of lignin in the mixture is between about 10 wt % to about 30 wt %.

18. The method of claim 15, wherein the crosslinking agent comprises at least one bifunctional compound having a first functional group reactive with hydroxyl groups and a second functional group having a double bond.

19. The method of claim 15, wherein the colloidal lignin has a particle size of between about 20 nm to about 50 nm.

20. The method of claim 19, wherein the colloidal lignin has a particle size of about 30 nm.

21. The method of claim 15, wherein the crosslinking agent is present in the mixture at levels of between about 0.1 wt % to about 4 wt %.

22. The method of claim 21, wherein the crosslinking agent is present in the mixture at levels of between about 0.1 wt % to about 1 wt %.

23. The method of claim 15 wherein the at least one crosslinking agent is selected from the following compounds: 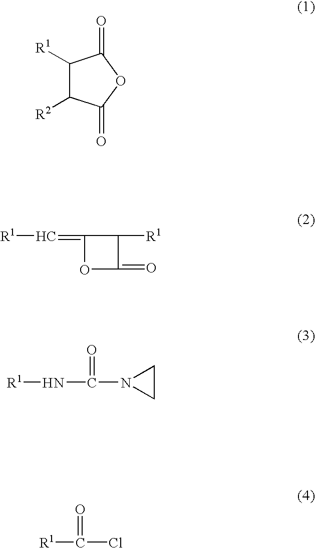
wherein R¹ is a C₃ to C₂₄ branched or unbranched chain having at least one double bond and R₂ is H or lower alkyl having from 1 to 6 carbon atoms.

24. The method of claim 23, wherein the at least one crosslinking agent is an alkenyl succinic anhydride or an alkylketene dimer.

25. The method of claim 24, wherein the alkenyl succinc anhydride is selected from the group consisting of dodecynyl succinic anhydride, hexadecynyl succinic anhydride, ocatadecynyl succinic anhydride or mixtures of any two or more thereof.

26. The method of claim 15 wherein the aqueous lignin mixture comprises ammonia.

27. The method of claim 15, wherein curing occurs at a temperature of between about 80° C. to about 100° C.

28. The method of claim 15, wherein the aqueous lignin mixture further comprises a plasticizer.

29. The method of claim 28, wherein the plasticizer is a polyol.

30. The method of claim 15, wherein the lignin is obtained from sugar cane bagasse.

31. The method of claim 30, wherein the lignin has been fractionated from the bagasse by an organosolv or soda process.

32. (canceled)

33. A composition for treating a paper product, the composition comprising lignin mixed in an aqueous solution at a concentration and pH such that the lignin is present in both soluble and colloidal form, and a crosslinking agent.

34. A composition for treating a paper product, the composition comprising lignin mixed in an aqueous solution at a concentration of between about 10 wt % and about 30 wt %. and a pH of between about 8 to about 10 such that the lignin is present in both soluble and colloidal form and a crosslinking agent, wherein the crosslinking agent comprises at least one bifunctional compound having a first functional group reactive with hydroxyl groups and a second functional group having a double bond.

35. (canceled)

36. A method of treating a paper product, the method comprising;
providing an aqueous mixture of lignin having a concentration and pH such that lignin is present in both soluble and colloidal form;
adding an amphiphilic polymer to the lignin mixture, the amphiphilic polymer being capable of temperature dependent self assembly such that it becomes more hydrophobic with an increase in temperature;
treating the paper product with the mixture; and
allowing the mixture to cure.

37. The method of claim 36, wherein the amphiphilic polymer is a silicone polyol.

38. The method of claim 37, wherein the silicone polyol has the formula: 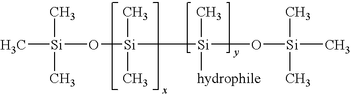
wherein the hydrophile has the formula;
C₃H₆O-(EO)m-(PO)n-R;
where EO is ethylene oxide —[CH₂—CH₂—O]m-; PO is propylene oxide —[CH₂—CH(CH₃)—O]n-, either, but not both, of m and n may be 0 and R is methyl, ethyl, butyl or propyl and X, y, m and/or n are selected such that the molecular weight of the polyol is between about 2000 to about 10000, typically between about 4000 and about 6000.

39. The method of claim 36, wherein the colloidal lignin has a particle size of between about 20 nm to about 50 nm.

40. The method of claim 39, wherein the colloidal lignin has a particle size of about 30 nm.

41. The method of claim 36 wherein the aqueous mixture comprises ammonia.

42. The method of claim 36, wherein the amphiphilic polymer is present in the mixture in an amount of between 0.5 wt % to about 4 wt %.

43. The method of claim 42 wherein the amphiphilic polymer is present in the mixture in an amount of between about 1 wt % to about 2 wt %.

44. The method of claim 36, wherein curing occurs at a temperature of between about 80° C. to about 100° C.

45. The method of claim 36, wherein the lignin is obtained from sugar cane bagasse.

46. The method of claim 45, wherein the lignin has been fractionated from the bagasse by an organosolv or soda process.

47. (canceled)

48. A composition for treating a paper product, the composition comprising lignin mixed in an aqueous solution at a concentration and pH such that the lignin is present in both soluble and colloidal form and an amphiphilic polymer that is capable of temperature dependent self assembly to the lignin mixture whereby the polymer becomes more hydrophobic upon drying.

49. A composition for treating a paper product, the composition comprising lignin mixed in an aqueous solution having a concentration of between about 10 wt % and about 30 wt % and a pH of between about 8 to about 10 such that the lignin is present in both soluble and colloidal form and a silicone polyol.

50. (canceled)
